(19) United States
(12) Patent Application Publication
(10) Pub. No.: US 2014/0175971 A1
(43) Pub. Date: Jun. 26, 2014

(54) WHITE LIGHT-EMITTING DEVICE

(71) Applicant: Kabushiki Kaisha Toshiba, Minato-ku (JP)

(72) Inventors: Naotoshi MATSUDA, Chigasaki-shi (JP); Yasushi Hattori, Kawasaki-shi (JP); Yumi Fukuda, Tokyo (JP); Iwao Mitsuishi, Tokyo (JP); Keiko Albessard, Yokohama-shi (JP)

(73) Assignee: Kabushiki Kaisha Toshiba, Minato-ku (JP)

(21) Appl. No.: 14/134,293

(22) Filed: Dec. 19, 2013

(30) Foreign Application Priority Data
Dec. 25, 2012 (JP) 2012-281119

(51) Int. Cl. F21K 99/00

(52) U.S. Cl. CPC F21K 9/56
USPC 313/503

(57) ABSTRACT

The embodiment of the present disclosure provides a light-emitting device capable of both realizing neutral white color and having high luminous efficiency. The device has a blue-light emitting semi-conductor element and a luminescent layer containing a mixture of fluorescent substances. The mixture contains first and second phosphors. The first phosphor is activated with Ce and emits luminescence with a peak wavelength of 540 to 560 nm, and the second phosphor emits luminescence with a peak wavelength of 580 to 610 nm and is represented by the following formula (2):

(Sr₁₋ₓ₂Euₓ₂) Siₐ₂Al_{b2}O_{c2}N_{d2}Cₑ₂ (2).

### CROSS-REFERENCE TO RELATED APPLICATIONS

This application is based upon and claims the benefit of priority from the Japanese Patent Application No. 2012-281119, filed on Dec. 25, 2012, the entire contents of which are incorporated herein by reference.

### FIELD

Embodiments of the present disclosure relate to a light-emitting device suitably used as a light source for general illumination.

### BACKGROUND

A light-emitting device, which is a single device comprising a fluorescent substance and a light-emitting semi-conductor element in combination so as to give off white light, is becoming popularly used nowadays as a light source for illumination and the like. For example, there is a known typical white light-emitting device in which a yellow-light emitting fluorescent substance is combined with a blue-light emitting element of semi-conductor nitride LED. In this type of device, phosphors such as Y₃Al₅O₁₂:Ce and M₂SiO₄:Eu (in which M is an alkaline earth metal) have been conventionally adopted as the fluorescent substance which emits yellow luminescence under excitation by blue light. However, in recent years, studies have been made on yellow-light emitting Ce-activated oxynitride phosphors, which are generally represented by the formula: (Sr₁₋ₓCeₓ)SiₐAl_{b}O_{c}N_{d} or the like, in order that they may be applied to the light-emitting devices. Those oxynitride phosphors are categorized into a group of fluorescent substances referred to as “SiAlON”, and are characterized in that their emission intensities are hardly weakened even when the temperature rises and also in that they hardly suffer from degradation over time.

However, it has been found that, if the SiAlON phosphor and a blue-light emitting LED element are combined to produce a light-emitting device, it is difficult for the device to completely realize neutral white color, which is a representative chromaticity standard, with a correlated color temperature of about 5000 K. In view of enhancing practicality of the light-emitting device, it is very important to realize the neutral white color. Meanwhile, for the purpose of realizing white color chromaticity in a wide range, it is studied to incorporate a red-light emitting fluorescent substance into a yellow- or green-light emitting one. According to that technique, the above SiAlON phosphor may be doped with a representative red-light emitting fluorescent substance such as CaAlSiN₃:Eu. This apparently makes it possible to completely realize the chromaticity with a correlated color temperature of about 5000 K.

However, if thus incorporated, the red-light emitting fluorescent substance absorbs yellow light and consequently lowers the luminous efficiency of the light-emitting device as a whole. Accordingly, there is room for further improvement.

### BRIEF DESCRIPTION OF THE DRAWINGS

FIG. 1 shows a vertical sectional view schematically illustrating a light-emitting device according to an embodiment of the present disclosure.

FIG. 2 shows an emission spectrum of the light-emitting device in Comparative example 1.

FIG. 3 shows an emission spectrum of the light-emitting device in Example 1.

### DETAILED DESCRIPTION

Embodiments will now be explained with reference to the accompanying drawings.

A light-emitting device according to the embodiment of the present disclosure comprises:

a semi-conductor element which emits a blue light; and a luminescent layer containing a mixture of

(A) a first phosphor which is activated with Ce and which emits luminescence with a peak in the wavelength range of 540 to 560 nm under excitation by blue light, and

(B) a second phosphor which emits luminescence with a peak in the wavelength range of 580 to 610 nm under excitation by blue light,

wherein the second phosphor is represented by the following formula (2):

(Sr₁₋ₓ₂Euₓ₂) Siₐ₂Al_{b2}O_{c2}N_{d2}Cₑ₂ (2)

in which

x2, a2, b2, c2, d2 and e2 are numbers satisfying the conditions of

0<x2≦1,

3.5≦a2≦4.0,

1.0≦b2≦2.0,

0.25≦c2≦1.0,

5.5≦d2≦7.0, and

0≦e2≦0.1, respectively.

### Mixture of Fluorescent Substances

The light-emitting device according to the embodiment of the present disclosure comprises a blue-light emitting semi-conductor element and a mixture of fluorescent substances that emit luminescence under excitation by the blue light. The mixture of fluorescent substances contains at least the following two phosphors.

### (1) First Phosphor

The first phosphor is activated with Ce and emits luminescence with a peak in the wavelength range of 540 to 560 nm under excitation by blue light. Any fluorescent substance can be adopted as the first phosphor. Examples of the usable phosphor include oxynitride phosphors and garnet type phosphors such as Y₃Al₅O₁₂:Ce.

In the embodiment of the present disclosure, it is particularly preferred to adopt an oxynitride phosphor having a matrix of essentially the same crystal structure as that of Sr₂Si₇Al₃ON₁₃.

The “oxynitride phosphor having a matrix of essentially the same crystal structure as that of Sr₂Si₇Al₃ON₁₃” can be said to be based on Sr₂Si₇Al₃ON₁₃, but its constituting elements Sr, Si, Al, O and N are replaced with other elements and/or the matrix is fused with other metal elements such as Ce to form a solid solution. These modifications such as replacement often slightly change the crystal structure. However, the atomic positions therein are seldom changed so greatly as to break the chemical bonds among the skeleton atoms. Here, the atomic positions depend on the crystal structure, on the sites occupied by the atoms therein and on their atomic coordinates.

The embodiment of the present disclosure can obtain the aimed effect on the condition that the first phosphor has essentially the same crystal structure as Sr₂Si₇Al₃O₁₃. There may be a case where the crystal structure of the first phosphor differs from that of Sr₂Si₇Al₃ON₁₃ in the lattice constants and/or in the chemical bond lengths (close interatomic distances) of Sr—N and Sr—O. However, even in that case, if the differences are within a range of ±15% based on the lattice constants or chemical bond lengths (Sr—N and Sr—O) in Sr₂Si₇Al₃ON₁₃, the crystal structures are defined as essentially the same. Here, the lattice constants can be determined by X-ray diffraction or neutron diffraction, and the chemical bond lengths (close interatomic distances) of Sr—N and Sr—O can be calculated from the atomic coordinates.

The Sr₂Al₃Si₇ON₁₃ crystal belongs to an orthorhombic system with lattice constants of a=11.8 Å, b=21.6 Åand c=5.01 Å. This crystal also belongs to the space group Pna21 (which is the 33^{rd} space group listed in International Tables for Crystallography, Volume A: Space-group symmetry, edited by T. Hahn, published by Springer (Netherlands)). The chemical bond lengths (Sr—N and Sr—O) in Sr₂Si₇Al₃ON₁₃ can be calculated from the atomic coordinates shown in Table 1.

TABLE 1

| | Site | SOF* | x | y | z |
|---|---|---|---|---|---|
| Sr1 | 4a | 1 | 0.2786 | 0.49060(11) | 0.5284(14) |
| Sr2 | 4a | 1 | 0.3552(3) | 0.69839(12) | 0.048(2) |
| Si/Al1 | 4a | 1 | 0.3582(9) | 0.2769(3) | 0.070(3) |
| Si/Al2 | 4a | 1 | 0.5782(9) | 0.7996(4) | 0.047(5) |
| Si/Al3 | 4a | 1 | 0.5563(8) | 0.4672(3) | 0.543(5) |
| Si/Al4 | 4a | 1 | 0.4724(8) | 0.6092(3) | 0.556(4) |
| Si/Al5 | 4a | 1 | 0.1910(7) | 0.6397(3) | 0.535(4) |
| Si/Al6 | 4a | 1 | 0.0061(8) | 0.5438(3) | 0.546(4) |
| Si/Al7 | 4a | 1 | 0.1625(9) | 0.5661(3) | 0.038(4) |
| Si/Al8 | 4a | 1 | 0.3937(8) | 0.3469(3) | 0.547(4) |
| Si/Al9 | 4a | 1 | 0.1552(18) | 0.3483(8) | 0.318(3) |
| Si/Al10 | 4a | 1 | 0.1525(14) | 0.3492(6) | 0.813(2) |
| O/N1 | 4a | 1 | 0.436(2) | 0.8164(10) | 0.061(11) |
| O/N2 | 4a | 1 | 0.699(2) | 0.4692(10) | 0.513(10) |
| O/N3 | 4a | 1 | 0.334(2) | 0.6355(10) | 0.511(9) |
| O/N4 | 4a | 1 | 0.213(2) | 0.2980(11) | 0.056(12) |
| O/N5 | 4a | 1 | 0.256(2) | 0.3750(10) | 0.563(9) |
| O/N6 | 4a | 1 | 0.894(2) | 0.6002(12) | 0.549(14) |
| O/N7 | 4a | 1 | 0.358(3) | 0.2062(12) | 0.893(6) |
| O/N8 | 4a | 1 | 0.508(2) | 0.4677(12) | 0.885(6) |
| O/N9 | 4a | 1 | 0.398(2) | 0.2727(12) | 0.392(6) |
| O/N10 | 4a | 1 | 0.430(3) | 0.3336(15) | 0.896(7) |
| O/N11 | 4a | 1 | 0.942(3) | 0.4614(15) | 0.371(8) |
| O/N12 | 4a | 1 | 0.662(2) | 0.8571(12) | 0.893(6) |
| O/N13 | 4a | 1 | 0.128(3) | 0.5743(15) | 0.381(7) |
| O/N14 | 4a | 1 | 0.495(3) | 0.3982(13) | 0.383(6) |

Remark) SOF*: site occupation factor

In the embodiment of the present disclosure, the first phosphor has the above crystal structure except that the constituting element Sr is partly replaced with the emission center element Ce. The composition of the elements constituting the phosphor is so selected as to ensure the above-described structure. Specifically, the first phosphor is preferably an oxynitride represented by the following formula (1):

(Sr₁₋ₓ₁Ceₓ₁) Siₐ₁Al_{b1}O_{c1}N_{d1}Cₑ₁ (1)

in which

x1, a1, b1, c1, d1 and e1 are numbers satisfying the conditions of

0<x1≦1, preferably 0.01≦x1≦0.1,

3.5≦a1≦4.0,

1.0≦b1≦2.0, preferably 1.3≦b1≦1.8,

0.1≦c1≦0.5,

6.0≦d1≦7.5, and

0≦e1≦0.1, respectively.

As shown in the formula (1), the element Sr in the Sr₂Si₇Al₃ON₁₃ crystal structure is at least partly replaced with the emission center element Ce. In order to obtain sufficient luminous efficiency, the number x1 is preferably 0.01 or more. The element Sr may be completely replaced with Ce (that is, x1 may be 1), but the number xi is preferably 0.1 or less so as to avoid decrease of the emission efficiency (namely, to avoid concentration quenching).

Since containing the emission center element Ce, the first phosphor emits yellow light, namely, luminescence with a peak in the wavelength range of 540 to 560 nm when excited by blue light. The element Ce may be partly replaced with other emission center elements.

In the first phosphor, the element Sr may be partly replaced with at least one element selected from the group consisting of Ba, Ca and Mg. However, the total amount of Ba, Ca and Mg is preferably 15 at. % or less, further preferably 10 at. % or less based on the amount of Sr so that variant phases may not be formed in the production process of the phosphor.

The number a1 is preferably 3.5 to 4.0 inclusive so as to obtain a phosphor having both of the aimed crystal structure and high luminous efficiency. If the number a1 is out of the above range, it is often impossible to obtain the phosphor having the aimed crystal structure or sufficient luminous efficiency.

Further, in order to obtain the phosphor having both of the aimed crystal structure and high luminous efficiency, the number b1 is also preferably 1.0 to 2.0 inclusive. The number b1 is more preferably 1.3 to 1.8 inclusive so as to realize higher luminous efficiency.

The emission peak wavelength largely depends on the oxygen content. Specifically, if the number c1 is too small, the phosphor often shows luminescence with a peak at a wave-length longer than the aimed one. Accordingly, the number c1 is preferably 0.1 or more. Further, if the number c1 is too small, the variant phases tend to be formed and the luminous efficiency is often lowered. On the other hand, however, if the number c1 is too large, the phosphor often shows luminescence with a peak at a wavelength shorter than the aimed one. Accordingly, the number c1 is preferably 0.5 or less.

In order to obtain the phosphor having both of the aimed crystal structure and high luminous efficiency, the number d1 is still also preferably 6.0 to 7.5 inclusive. If the number d1 is out of the above range, it is often impossible to obtain the phosphor having the aimed crystal structure or the variant phases tend to be formed in the production process of the phosphor, and consequently the emission often cannot be observed in the aimed wavelength range or the luminous efficiency may be lowered.

The number e1 corresponds to the amount of carbon contained in the phosphor. In the case where an oxygen-containing substance is adopted as one of the phosphor materials, carbon may be added together as one of the materials to form an intermediate product and thereby to control the oxygen content in the phosphor. However, if the carbon content e1 is too large in that case, the phosphor often shows luminescence with a peak at a wavelength longer than the aimed one and/or the luminous efficiency is often lowered. Accordingly, in order to obtain the aimed emission peak wavelength, the number el is preferably 0.1 or less.

The emission peak wavelength of the first phosphor depends on the ratio between Ce and O contained therein. Specifically, when the oxygen content relatively increases, the emission peak wavelength tends to be blue-shifted. In consideration of that, the ratio by number of O atoms to Ce atoms is preferably 0.1 to 0.5 inclusive. In the case where the first phosphor contains an alkali metal other than Ce, the total number of Ce and the alkali metal atoms preferably satisfies the above relation to the number of O atoms.

In the embodiment of the present disclosure, the crystal structure of the first phosphor can be identified by XRD or neutron diffraction. Since having essentially the same crystal structure, the first phosphor shows essentially the same XRD profile as Sr₂Si₇Al₃ON₁₃, for example.

Specifically, in the X-ray diffraction pattern measurement with Cu—Kα line radiation according to Bragg-Brendano method, the first phosphor shows peaks at particular diffraction angles (2θ) that are the same as those of Sr₂Si₇Al₃ON₁₃. This means that the pattern of the first phosphor has at least ten peaks at the diffraction angles (2θ) of 15.05 to 15.15, 23.03 to 23.13, 24.87 to 24.97, 25.7 to 25.8, 25.97 to 26.07, 29.33 to 29.43, 30.92 to 31.02, 31.65 to 31.75, 31.88 to 31.98, 33.02 to 33.12, 33.59 to 33.69, 34.35 to 34.45, 35.2 to 35.3, 36.02 to 36.12, 36.55 to 36.65, 37.3 to 37.4 and 56.5 to 56.6.

The first phosphor according to the present embodiment can be produced by the steps of mixing powdery materials containing the above elements and then firing the mixture.

The Sr material can be selected from the group consisting of nitride, oxide and hydroxide of Sr; the Al material can be selected from the group consisting of nitride and oxide of Al; the Si material can be selected from the group consisting of nitride, oxide and powdery simple substance of Si; and the emission center element Ce material can be selected from the group consisting of oxide, nitride and halogenated compounds of Ce. Further, the C material is powdery carbon, such as, graphite, carbon black, activated carbon or amorphous carbon, which can be freely selected according to the aimed phosphor.

In addition, nitrogen can be supplied from the above nitrides or from a nitrogen-containing firing atmosphere, and oxygen can be supplied from the above oxides or from surface oxidized films of the above nitrides.

For example, Sr₃N₂, Si₃N₄, Al₂O₃ or AlN, CeO₂ and carbon powder are mixed in such loading amounts as give the aimed contents. The material Sr₃N₂ may be replaced with Sr₂N, SrN, a mixture thereof or the like.

If nitrides are mainly used, the materials are mixed, for example, in a mortar in a glove box. The material mixture is placed in a crucible and then fired under particular conditions to obtain the first phosphor according to the present embodiment. There are no particular restrictions on the materials of the crucible, and the crucible material can be selected from the group consisting of boron nitride, silicon nitride, silicon carbide, carbon, aluminum nitride, SiAlON, aluminum oxide, molybdenum and tungsten. It is preferred to use a crucible made of non-oxide material such as boron nitride or carbon.

The material mixture is preferably fired under a pressure not less than the atmospheric pressure. Since the silicon nitride hardly decomposes, it is advantageous to fire the mixture under a pressure not less than the atmospheric pressure. In order to prevent the silicon nitride from decomposing at a high temperature, the pressure is preferably 5 atm or more and the firing temperature is preferably in the range of 1500 to 2000° C. If those conditions are satisfied, the aimed fired product can be obtained without suffering from troubles such as sublimation of the materials and/or of the product. The firing temperature is more preferably in the range of 1800 to 2000° C. Prior to the firing procedure for producing the aimed phosphor, it is possible to beforehand synthesize an intermediate product from which the phosphor having the aimed composition can be synthesized. For example, in the case where an oxygen-containing Sr material such as strontium hydroxide is adopted, the phosphor of the aimed composition can be favorably obtained by a process comprising the steps of reacting the Sr material with a Si material and an activator material so as to produce an intermediate product and then additionally mixing the Si material and an Al material with the intermediate product. In producing the intermediate product, it is also preferred that the materials be fired together with carbon powder so as to control the oxygen content of the phosphor. The firing temperature for producing the intermediate product may be lower than 1800° C.

For the purpose of avoiding oxidation of AlN, the firing step is preferably carried out in a nitrogen atmosphere. The atmosphere may contain hydrogen in an amount of about 90 atm % or less.

After the firing step is carried out at the above temperature for 0.5 to 4 hours, the fired product is taken out of the crucible and then pulverized. The pulverized product is preferably fired again under the same conditions. If those procedures in series of taking out, pulverizing and firing again are repeated 0 to 10 times, the product can obtain advantages that the crystal grains are less fused and hence that the formed powder is uniform both in composition and in crystal structure.

If necessary, the firing step can be divided into two or more stages carried out separately. For example, an oxynitride phosphor containing carbon atom can be produced by the following three-stage firing step. In the first stage, an alkaline earth metal oxide or hydroxide, strontium oxide or hydroxide, europium oxide, and silicon power or silicon nitride are mixed and fired in an atmosphere containing hydrogen and nitrogen, to synthesize a first intermediate product. Here, two or more alkaline earth metals may be used in combination, and they preferably contain strontium. This means that strontium oxide or hydroxide is preferably adopted as one of the materials. Although strontium oxide and hydroxide are hygroscopic compounds, they can be subjected to handling such as weighing or blending in atmosphere unless left for long time. Further, they are inexpensive and hence it is industrially significant that they can be used in place of Sr₃N₂, which is expensive and unstable.

In the production process according to the embodiment of the present disclosure, the firing container used in the first stage firing is preferably made of non-oxide material. For example, it is preferred to use a boron nitride (BN)-made or silicon carbide (SiC)-made container. Those containers enable to sufficiently reduce the oxygen content in the first intermediate product obtained by the first stage. In contrast, if a container made of oxide such as alumina is used, the oxygen content in the first intermediate product is so increased that many variant phases are formed in the resultant oxynitride phosphor. That should be paid attention to. Since the variant phases decrease luminescence of the phosphor, the phosphor containing many variant phases has low luminous efficiency.

In the production process according to the embodiment of the present disclosure, the materials of the first stage include a compound of europium which functions as an emission center and a compound of silicon which partly constitutes the phosphor crystal. As the europium compound, Eu₂O₃ is adopted. Other europium compounds such as EuN are also usable, but Eu₂O₃ is preferred in view of the cost. Nevertheless, in the case where the oxygen content in the first intermediate product needs to be very small, it is possible to use EuN together with Eu₂O₃ in a high ratio. As the silicon compound, Si₃N₄ or Si powder is adopted. Since having low oxygen contents, those silicon substances are advantageous in keeping the oxygen content low in the first intermediate product. In addition, those materials are so chemically stable that they can be handled without any trouble in atmosphere.

The first intermediate product obtained by the first stage contains a component represented by (M,Eu)₂Si₅N₈. This component emits orange or red luminescence with a peak wavelength of 600 nm or more. Further, the first intermediate product may contain other oxygen-containing components such as (M,Eu)₂SiO₄ and (M,Eu) Si₂O₂N₂. However, in order to obtain the aimed phosphor containing a small amount of variant phases, it is necessary for the first intermediate product to have a small molar ratio of oxygen to the total of M and Eu. That molar ratio is preferably less than 1.0. If the first intermediate product has too large an oxygen content, it is difficult to prevent formation of oxygen-rich variant phases in the following stages. The firing temperature of the first stage is preferably 1300 to 1600° C. If the temperature is lower than that range, it is feared that the (M,Eu)₂Si₅N₈ phase may be insufficiently formed. On the other hand, if the temperature is higher than the range, the composition tends to deviate from the aimed one.

The first stage firing is carried out in an atmosphere containing hydrogen and nitrogen. Specifically, the firing is carried out in a reductive atmosphere so as to reduce the oxygen content in the first intermediate product. There are no particular restrictions on the ratio between hydrogen and nitrogen in the atmosphere, but the ratio is normally 2:98 to 75:25. The atmosphere may contain other inert gases, but needs to contain oxygen in as small an amount as possible. There are also no particular restrictions on the firing pressure, and the first stage firing is normally carried out under the atmospheric pressure.

Subsequently, in the second stage, a second intermediate product is synthesized. Specifically, the first intermediate product obtained in the first stage is mixed with carbon powder, and then the mixture is fired in an atmosphere containing hydrogen and nitrogen.

In this stage, it is presumed that oxygen atoms of oxygen-containing components, such as (M,Eu)₂SiO₄ and (M,Eu) Si₂O₂N₂, in the first intermediate product be combined with carbon atoms, thereby that excess of oxygen over the desired amount be removed and, at the same time, that a small amount of carbon be included in the crystal to form a second intermediate product. The amount of mixed carbon powder in the second stage is preferably 1.0 to 2.0 times as large as the total amount of the alkaline earth metal and europium in terms of molar ratio. If the amount of mixed carbon is smaller than that range, the oxygen is so insufficiently removed that the resultant red phosphor cannot emit luminescence in a wavelength range of 630 nm or longer. On the other hand, however, if the amount is larger than the above range, unreacted carbon remains to lower the luminous efficiency.

There are no particular restrictions on the carbon powder. Examples of the carbon powder include graphite, carbon black, activated carbon or amorphous carbon, which can be freely selected according to the aimed phosphor. However, graphite and activated carbon are preferred in view of the availability and cost.

The firing temperature of the second stage is preferably 1300 to 1600° C. In the same manner as the first stage firing, the second stage firing is carried out in an atmosphere containing hydrogen and nitrogen. The firing atmosphere of the second stage can be selected from the scope described above for that of the first stage. However, the second stage firing does not need to be carried out under the same conditions as the first stage firing.

The present applicant has studied and found that a red phosphor produced without the second stage emits luminescence with as short a peak wavelength as less than 630 nm. The reason of that is not clearly revealed, but it is presumed that oxygen originally contained in the strontium material remain in the resultant phosphor to increase the oxygen content, namely, the number c1 in the formula (1).

Thereafter, in the third stage, the second intermediate product is mixed with supplementary materials by which the composition is adjusted to the aimed oxynitride phosphor, and then the mixture is fired in an atmosphere containing hydrogen and nitrogen.

The supplementary materials are aluminum nitride and silicon nitride, silicon powder or a combination thereof. Here, non-oxide compounds are adopted as the materials so that the oxygen content in the resultant oxynitride phosphor can be controlled in the same manner as in the first stage.

In view of the reactivity, the silicon powder preferably has a small mean particle size. Specifically, the mean particle size is preferably less than 150 μm, more preferably less than 50 μm. However, if the silicon powder contains oxygen or impurities, variant phases tend to be formed and hence the luminescent properties may be impaired. In consideration of that, the silicon powder preferably has a large mean particle size. Specifically, the mean particle size is preferably 5 μm or more. Here, the “mean particle size” of the silicon powder means a 50% median diameter, which can be determined by means of, for example, a laser scattering-diffraction particle size distribution analyzer ([trademark], manufactured by HORIBA, LTD.).

In the case where the materials contain too small an amount of oxygen, aluminum oxide (Al₂O₃) can be additionally used as one of the materials so as to control the oxygen content of the resultant oxynitride phosphor. The amount ratio among the supplementary materials is so adjusted that the number of moles of M and Eu in total, that of Al (namely, the number of moles of Al in the aluminum nitride and the aluminum oxide), and that of Si (namely, the number of moles of Si in (M,Eu)₂Si₅N₈ and in the supplementary silicon nitride and/or silicon powder) may be in a ratio corresponding to the atomic ratio in the aimed phosphor composition. Specifically, the materials are so mixed that the mole ratio among M+Eu, Al and

Si in the materials of the third stage may correspond to 1:a:b in (M₁₋ₓEuₓ)AlₐSi_{b}O_{c}N_{d}Cₑ. However, in the third stage firing, Si may volatilize away. In that case, it is preferred to load the silicon powder or silicon nitride in an amount larger than the theoretical value.

The materials are fired preferably at a low firing temperature in view of the production cost. If the firing temperature is 1500° C. or more, it is possible to produce a phosphor having satisfying properties in most cases. Accordingly, the firing temperature is preferably 1500° C. or more.

In the same manner as the first stage firing and the second stage firing, the third stage firing is carried out also in an atmosphere containing hydrogen and nitrogen. The firing atmosphere of the third stage can be selected still also from the scope described above for that of the first stage. However, the third stage firing does not need to be carried out under the same conditions as the first or second stage firing.

There are no particular restrictions on the firing container. However, since the firing temperature is relatively high, it is preferred to use a BN-made crucible.

After the firing procedure is carried out in any manner, the product is subjected to after-treatment such as washing. The washing can be carried out, for example, by use of pure water or acid. Examples of the acid include: inorganic acids, such as sulfuric acid, nitric acid, hydrochloric acid and hydrofluoric acid; organic acids, such as formic acid, acetic acid and oxalic acid; and mixtures thereof.

After washed with acid, the product may be subjected to post-anneal treatment, if necessary. The post-anneal treatment, which can be carried out, for example, in a reductive atmosphere containing nitrogen and hydrogen, improves the crystallinity and the luminous efficiency.

### (2) Second Phosphor

The second phosphor in the embodiment of the present disclosure is represented by the following formula (2):

(Sr₁₋ₓ₂Euₓ₂) Siₐ₂Al_{b2}O_{c2}N_{d2}Cₑ₂ (2)

in which

x2, a2, b2, c2, d2 and e2 are numbers satisfying the conditions of

0<x2≦1, preferably 0.01≦x2≦0.1,

3.5≦a2≦4.0

1.0≦b2≦2.0, preferably 1.3≦b2≦1.8,

0.25≦c2≦1.0,

5.5≦d2≦7.0, and

0≦e2≦0.1, respectively;

and emits luminescence with a peak in the wavelength range of 580 to 610 nm under excitation by blue light. This phosphor also has a matrix of essentially the same crystal structure as that of Sr₂Si₇Al₃ON₁₃ like that represented by the formula (1). Accordingly, it can be identified by X-ray diffraction or the like in the same manner as the phosphor of the formula (1).

The second phosphor differs from that represented by the formula (1) in containing Eu as an emission center metal, and accordingly emits luminescence at a wavelength different from that of the phosphor represented by the formula (1). Since those phosphors emit luminescence at different wavelengths to improve color rendition, the embodiment of the present disclosure can realize neutral white color. In order to easily realize the neutral white color, the emission peak wavelengths of the first and second phosphors differ preferably by 20 to 70 nm from each other.

With respect to the elements except oxygen and nitrogen in the second phosphor, the constitution ratios are within the same ranges as those of the first phosphor. However, the constitution ratios of oxygen and nitrogen are different from those of the first phosphor, so as to control the emission wavelength.

Specifically, if the number c2 is too small, the emission wavelength often becomes longer than the aimed one. Accordingly, the number c2 is preferably 0.25 or more. Further, if the number c2 is too small, the variant phases tend to be formed and the luminous efficiency is often lowered. On the other hand, however, if the number c2 is too large, the luminescence often has a peak at a wavelength shorter than the aimed one. Accordingly, the number c2 is preferably 1.0 or less.

In order to obtain a phosphor having both of the aimed crystal structure and high luminous efficiency, the number d2 is preferably 5.5 to 7.0 inclusive. If the number d2 is out of the above range, it is often impossible to obtain the phosphor having the aimed crystal structure or the variant phases tend to be formed in the production process of the phosphor, and consequently the emission often cannot be observed in the aimed wavelength range or the luminous efficiency may be lowered.

In the second phosphor, the emission peak wavelength depends on the ratio between Eu and O contained therein. Specifically, when the oxygen content relatively increases, the emission peak wavelength tends to be blue-shifted. In consideration of that, the ratio by number of O atoms to Eu atoms is preferably 0.25 to 1 inclusive. In the case where the second phosphor contains an alkaline earth metal other than Eu, the total number of Eu and the alkaline earth metal atoms preferably satisfies the above relation to the number of O atoms.

The second phosphor can be produced in the same manner as the first one except for adopting Eu₂O₃, Eu₂N₃ or the like as the materials and for changing the blending amounts of the materials according to necessity.

In the embodiment of the present disclosure, the mixing ratio between the first and second phosphors is varied according to the emission intensity and absorption wavelength of each phosphor, but is generally in the range of 85:15 to 20:80. The mixing ratio is so controlled as to make it possible to realize luminescence of neutral white color in the aimed chromatic range, where both chromaticity values x and y are within a difference of ±0.001 from the chromaticity coordinate (0.345, 0.352) with a correlated color temperature of 5000 K. The chromaticity coordinate used here is that regulated by CIE1931.

### (3) Other Phosphors

In the embodiment of the present disclosure, the mixture of fluorescent substances may further contain phosphors other than the above first and second ones unless they impair the effect of the embodiment.

For example, it is possible to incorporate an oxynitride phosphor having a matrix of essentially the same crystal structure as that of Sr₂Si₇Al₃ON₁₃ but containing an emission center element other than Ce or Eu. Examples of the emission center element include Tb and Mn. The content of the phosphor containing an emission center element other than Ce or Eu is preferably 15% or less, further preferably 10% or less based on the total weight of the phosphors constituting the mixture of fluorescent substances, in order that the light-emitting device according to the embodiment of the present disclosure can have the aimed properties. Further, for the purpose of controlling the chromaticity of the emission given off from the device, small amounts of other phosphors can be incorporated. Examples of them include CaAlSiN₃:Eu, Y₃Al₅O₁₂:Ce and M₂SiO₄:Eu (in which M is an alkaline earth metal). In the case where phosphors other than Sr₂Si₇Al₃ON₁₃-type ones are incorporated as the additional fluorescent substances, their absorption wavelength ranges are different from those of the first and second phosphors and accordingly it should be noted that they may absorb luminescence emitted from the other phosphors to lower the luminous efficiency.

### Light-Emitting Semi-Conductor Element

The device according to the present embodiment comprises a light-emitting semi-conductor element. The light given off from the element excites the above mixture of fluorescent substances, and at the same time partly constitutes white light emitted from the device. For this reason, in the embodiment of the present disclosure, the light-emitting semi-conductor element preferably gives off blue light, specifically, light with a peak wavelength of 440 to 460 nm.

### Llight-Emitting Device

The light-emitting device according to the embodiment of the present disclosure adopts the above mixture of fluorescent substances, and thereby enables to realize neutral white color, which has been difficult to achieve in prior arts, and also to obtain high luminous efficiency. Here, the “neutral white color” means light with a correlated color temperature of 5000 K according to the JIS regulation.

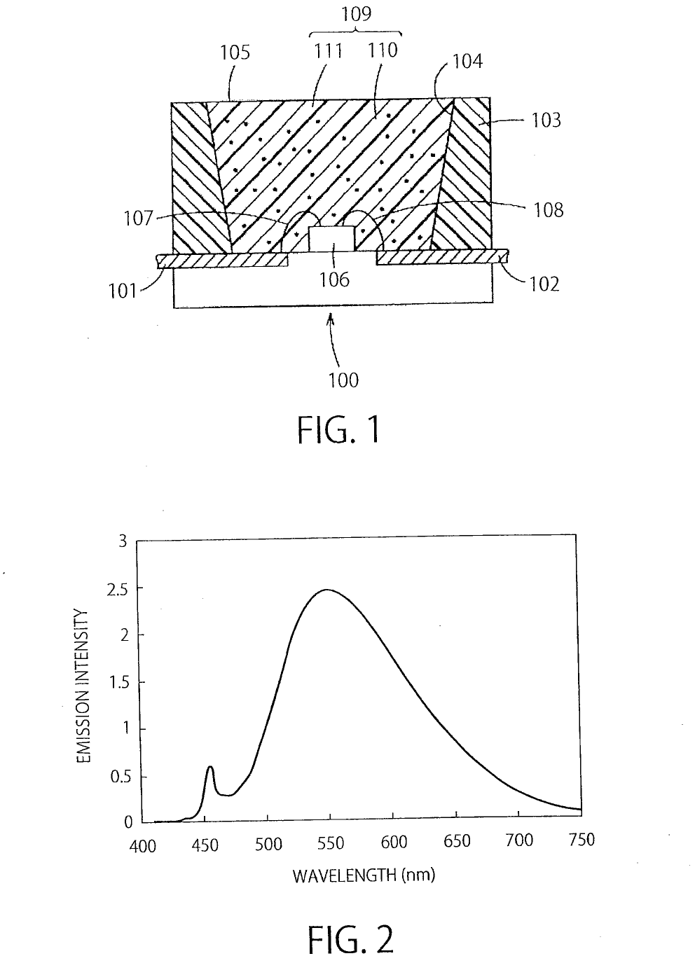

The device of the present embodiment comprises the above light emitting semi-conductor element and a luminescent layer containing the above mixture of fluorescent substances, and can be in any form of known devices. FIG. 1 shows a vertical sectional view schematically illustrating the light-emitting device according to an embodiment of the present disclosure.

In the light-emitting device shown in FIG. 1, the device 100 comprises leads 101 and 102, which are formed as a part of a lead frame, and also comprises a resin member 103, which is formed by integral molding with the lead frame. The resin member 103 has a concavity 105 in which the top opening is larger than the bottom. The inside wall of the concavity 105 is coated with a reflective surface 104.

At the center of the nearly circular bottom of the concavity 105, there is a light-emitting element 106 mounted with Ag paste or the like. Examples of the light-emitting semi-conductor element 106 include light-emitting diodes and laser diodes, such as a GaN type semi-conductor light-emitting element. The light-emitting element is so selected as to radiate light of proper wavelength according to the combination with the used mixture of fluorescent substances. The electrodes (not shown) of the light-emitting semi-conductor element 106 are connected to the leads 101 and 102 by way of bonding wires 107 and 108 made of Au or the like, respectively. The positions of the leads 101 and 102 can be adequately modified.

In the luminescent layer 109, the mixture 110 of the first and second phosphors is dispersed or precipitated in a resin layer 111 made of, for example, silicone resin in an amount of 5 to 50 wt %.

The light-emitting semi-conductor element 106 may be of a flip chip type in which the n- and p-electrodes are placed on the same plane. This element can avoid troubles concerning the wires, such as disconnection or dislocation of the wires and light-absorption by the wires. Accordingly, that element enables to obtain a semiconductor light-emitting device excellent both in reliability and in luminance. Further, it is also possible to adopt a light-emitting semi-conductor element 106 having an n-type substrate so as to produce a light-emitting device constituted as described below. Specifically, in that device, an n-electrode is formed on the back surface of the n-type substrate while a p-electrode is formed on the top surface of a semiconductor layer on the substrate. The n- or p-electrode is mounted on one of the leads, and the p- or n-electrode is connected to the other lead by way of a wire. The size and kind of the light-emitting element 106 and the dimension and shape of the concavity 105 can be properly changed.

The light-emitting device according to the embodiment of the present disclosure is not restricted to the package cup-type shown in FIG. 1, and can be freely modified. For example, even if the mixture of fluorescent substances in the embodiment is adopted in a shell-type or surface-mount type light-emitting device, the same effect can be obtained.

Embodiments of the present disclosure are further explained in detail by use of the following examples, in which the emission spectra of the white-light emitting devices and those of the phosphors under excitation by blue light were measured by means of a multi-channel spectrophotometer such as PMA-50 ([trademark], manufactured by Hamamatsu Photonics K.K.). Further, the chromaticity coordinates were calculated from the obtained emission spectra according to the method regulated in JIS Z 8701.

### Comparative Example 1

A blue-emitting InGa-type LED showing a peak wavelength of 450 nm was coated with a first phosphor showing an emission peak wavelength of 548 nm and represented by the formula: (Sr₁₋ₓ₁Ceₓ₁)Siₐ₁Al_{b1}O_{c1}N_{d1}Cₑ₁ on the conditions of x1=0.01, a1=3.97, b1=1.67, c1=0.28, d1=7.03 and e1=0.05, to produce a while-light emitting device of Comparative example 1 having a structure shown in FIG. 1. FIG. 2 shows a spectrum of white light emitted from the produced device. The amount of the phosphor was then varied to change the chromaticity of the white emission. However, as a result, it was impossible to realize the white color with a chromaticity coordinate in the range of (0.345±0.001, 0.352±0.001), which corresponds to a correlated color temperature of 5000 K. Even the realized chromaticity coordinate nearest to the above range was (0.322, 0.363), which was out of the regulated range of the neutral white color. Further, the realized white light with the chromaticity coordinate of (0.322, 0.363) was evaluated on the general color rendering index Ra. As a result, it was found to be as low as 68, which was insufficient to use for general illumination.

### Example 1

The procedure of Comparative example 1 was repeated except for using a mixture of fluorescent substances, to produce a white-light emitting device. The mixture was composed of: the same first phosphor as that in Comparative exmaple1, which showed an emission peak wavelength of 548 nm and was represented by the formula: (Sr₁₋ₓ₁Ceₓ₁)Siₐ₁Al_{b1}O_{c1}N_{d1}Cₑ₁ on the conditions of x1=0.01, a1=3.97, b1=1.67, c1=0.28, d1=7.03 and e1=0.05; and

a second phosphor showing an emission peak wavelength of 586 nm and represented by the formula:

(Sr₁₋ₓ₂Euₓ₂)Siₐ₂Al_{b2}O_{c2}N_{d2}Cₑ₂;

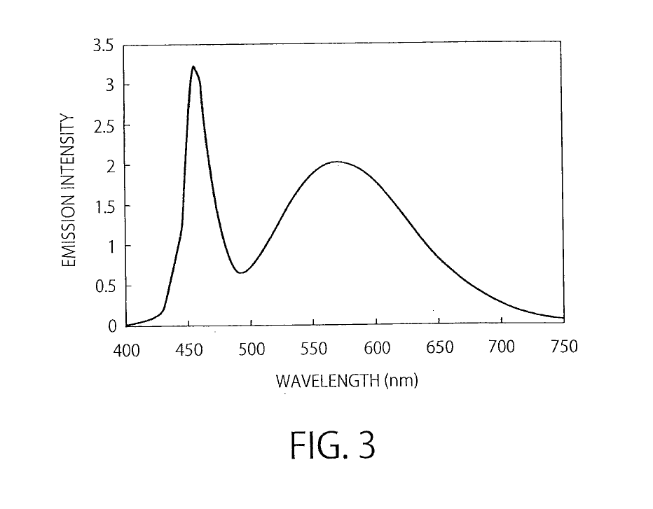

in a ratio by weight of 50:50. FIG. 3 shows a spectrum of white light emitted from the produced device, and the produced device succeeded in realizing the white color with a chromaticity coordinate in the range of (0.345±0.001, 0.352±0.001), which corresponds to a correlated color temperature of 5000 K. The realized white color had intensity of 97% of that obtained in Comparative example 1, and hence it was found that the second phosphor hardly lowered the luminous efficiency. The general color rendering index Ra was also found to be 77, which was enough to use for general illumination.

### Comparative Example 2

The procedure of Comparative example 1 was repeated except for using another mixture of fluorescent substances, to produce a white-light emitting device. The mixture was composed of:

the same first phosphor as that in Comparative exmaple1, which showed an emission peak wavelength of 548 nm and was represented by the formula: (Sr₁₋ₓ₁Ceₓ₁)Siₐ₁Al_{b1}O_{c1}N_{d1}Cₑ₁ on the conditions of x1=0.01, a1=3.97, b1=1.67, c1=0.28, d1=7.03 and e1=0.05; and
CaAlSiN₃:Eu phosphor showing an emission peak wavelength of 655 nm;
in a ratio by weight of 88:12. The produced device succeeded in realizing the white color with a chromaticity coordinate in the range of (0.345±0.001, 0.352±0.001), which corresponds to a correlated color temperature of 5000 K. Further, the general color rendering index Ra was found to be as high as 89. However, it was also found that the realized white color had as low intensity as 82% of that obtained in Comparative example 1.

### Example 2

The procedure of Example 1 was repeated except for changing the first phosphor and the mixing ratio by weight into YAG:Ce (emission peak wavelength: 553 nm) and 59:41, respectively, to produce a white-light emitting device having a structure shown in FIG. 1. The produced device succeeded in realizing the white color with a chromaticity coordinate in the range of (0.345±0.001, 0.352±0.001), which corresponds to a correlated color temperature of 5000 K. The realized white color had intensity of 99% of that obtained in Comparative example 1, and hence it was found that the second phosphor hardly lowered the luminous efficiency. The general color rendering index Ra was also found to be 75, which was enough to use for general illumination.

### Comparative Example 3

The procedure of Comparative example 1 was repeated except for changing the phosphor into YAG:Ce (emission peak wavelength: 553 nm), to produce a white-light emitting device. The produced device failed in realizing the white color with a chromaticity coordinate in the range of (0.345±0.001, 0.352±0.001), which corresponds to a correlated color temperature of 5000 K. Even the realized chromaticity coordinate nearest to the above range was (0.330, 0.360), which was out of the regulated range of the neutral white color. The realized white color was found to have as high intensity as 107% of that obtained in Comparative example 1. However, it was also found that the general color rendering index Ra was 69, which was too low a value to use for general illumination.

### Example 3

The procedure of Comparative example 1 was repeated except for using still another mixture of fluorescent substances, to produce a white-light emitting device. The mixture was composed of:

a first phosphor, which was a Ce-activated SiAlON (emission peak wavelength: 555 nm) represented by the formula: (Sr₁₋ₓ₁Ceₓ₁)Siₐ₁Al_{b1}O_{c1}N_{d1}Cₑ₁ on the conditions of x1=0.03, a1=3.83, b1=1.80, c1=0.20, d1=7.08 and e1=0.02; and the same second phosphor as that in Exmaple1, which was a Eu-activated SiAlON (emission peak wavelength: 586 nm) represented by the formula: (Sr₁₋ₓ₂Euₓ₂)Siₐ₂Al_{b2}O_{c2}N_{d2}Cₑ₂ on the conditions of x2=0.02, a2=3.59, b2=1.59, c2=0.58, d2=6.20 and e2=0.01;
in a ratio by weight of 63:37. The produced device succeeded in realizing the white color with a chromaticity coordinate in the range of (0.345±0.001, 0.352±0.001), which corresponds to a correlated color temperature of 5000 K. The realized white color had intensity of 97% of that obtained in Comparative example 1, and hence it was found that the second phosphor hardly lowered the luminous efficiency. The general color rendering index Ra was also found to be 76, which was enough to use for general illumination.

### Example 4

The procedure of Comparative example 1 was repeated except for using yet another mixture of fluorescent substances, to produce a white-light emitting device. The mixture was composed of:

the same first phosphor as that in Comparative exmaple1, which was a Ce-activated SiAlON (emission peak wavelength: 548 nm) represented by the formula: (Sr₁₋ₓ₁Ceₓ₁)Siₐ₁Al_{b1}O_{c1}N_{d1}Cₑ₁ on the conditions of x1=0.01, a1=3.97, b1=1.67, c1=0.28, d1=7.03 and e1=0.05; and
a second phosphor, which was a Eu-activated SiAlON (emission peak wavelength: 582 nm) represented by the formula: (Sr₁₋ₓ₂Euₓ₂)Siₐ₂Al_{b2}O_{c2}N_{d2}Cₑ₂ on the conditions of x2=0.02, a2=3.70, b2=1.62, c2=0.62, d2=6.20 and e1=0.01; in a ratio by weight of 49:51. The produced device succeeded in realizing the white color with a chromaticity coordinate in the range of (0.345±0.001, 0.352±0.001), which corresponds to a correlated color temperature of 5000 K. The realized white color had intensity of 97% of that obtained in Comparative example 1, and hence it was found that the second phosphor hardly lowered the luminous efficiency. The general color rendering index Ra was also found to be 77, which was enough to use for general illumination.

### Example 5

The procedure of Comparative example 1 was repeated except for using still yet another mixture of fluorescent substances, to produce a white-light emitting device. The mixture was composed of:

the same first phosphor as that in Comparative exmaple1, which was a Ce-activated SiAlON (emission peak wavelength: 548 nm) represented by the formula: (Sr₁₋ₓ₁Ceₓ₁)Siₐ₁Al_{b1}O_{c1}N_{d1}Cₑ₁ on the conditions of x1=0.01, a1=3.97, b1=1.67, c1=0.28, d1=7.03 and e1=0.05; and

a second phosphor, which was a Eu-activated SiAlON (emission peak wavelength: 602 nm) represented by the formula: (Sr₁₋ₓ₂Euₓ₂)Siₐ₂Al_{b2}O_{c2}N_{d2}Cₑ₂ on the conditions of x2=0.05, a2=3.50, b2=1.44, c2=0.48, d2=6.52 and e1=0.02; in a ratio by weight of 73:27. The produced device succeeded in realizing the white color with a chromaticity coordinate in the range of (0.345±0.001, 0.352±0.001), which corresponds to a correlated color temperature of 5000 K. The realized white color had intensity of 93% of that obtained in Comparative example 1, and hence it was found that the second phosphor hardly lowered the luminous efficiency. The general color rendering index Ra was also found to be 80, which was enough to use for general illumination.

### Comparative Example 4

The procedure of Comparative example 1 was repeated except for using further still yet another mixture of fluorescent substances, to produce a white-light emitting device. The mixture was composed of:

the same first phosphor as that in Comparative exmaple1, which was a Ce-activated SiAlON (emission peak wavelength: 548 nm) represented by the formula: (Sr₁₋ₓ₁Ceₓ₁)Siₐ₁Al_{b1}O_{c1}N_{d1}Cₑ₁ on the conditions of x1=0.01, a1=3.97, b1=1.67, c1=0.28, d1=7.03 and e1=0.05; and a second phosphor, which was (Ca,Sr)AlSiN₃:Eu (emission peak wavelength: 628 nm);

in a ratio by weight of 93:7. The produced device succeeded in realizing the white color with a chromaticity coordinate in the range of (0.345±0.001, 0.352±0.001), which corresponds to a correlated color temperature of 5000 K. Further, the general color rendering index Ra was found to be as high as 86. However, it was also found that the realized white color had as low intensity as 89% of that obtained in Comparative example 1.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A light-emitting device, comprising
a semi-conductor element which emits a blue light; and
a luminescent layer containing a mixture of
(A) a first phosphor which is activated with Ce and which emits luminescence with a peak in the wavelength range of 540 to 560 nm under excitation by blue light, and
(B) a second phosphor which emits luminescence with a peak in the wavelength range of 580 to 610 nm under excitation by blue light,
wherein the second phosphor is represented by the following formula (2):
(Sr₁₋ₓ₂Euₓ₂) Siₐ₂Al_{b2}O_{c2}N_{d2}Cₑ₂ (2)
in which
x2, a2, b2, c2, d2 and e2 are numbers satisfying the conditions of
0<x2≦1,
3.5≦a2≦4.0,
1.0≦b2≦2.0,
0.25≦c2≦1.0,
5.5≦d2≦7.0, and
0≦e2≦0.1, respectively.

2. The device according to claim 1, wherein said first phosphor has a matrix of essentially the same crystal structure as that of Sr₂Si₇Al₃ON₁₃.

3. The device according to claim 1, wherein said first phosphor is represented by the following formula (1):
(Sr₁₋ₓ₁Ceₓ₁) Siₐ₁Al_{b1}O_{c1}N_{d1}Cₑ₁ (1)
in which
x1, a1, b1, c1, d1 and e1 are numbers satisfying the conditions of
0<x1≦1,
3.5≦a1≦4.0,
1.0≦b1≦2.0,
0.1≦c1≦0.5,
6.0≦d1≦7.5, and
0≦e1≦0.1, respectively.

4. The device according to claim 1, wherein said second phosphor has such a composition that the ratio of the number of oxygen atoms to the total number of alkaline earth metal and Eu atoms is in the range of 0.25 to 1 inclusive.

5. The device according to claim 1, wherein said first phosphor has such a composition that the ratio of the number of oxygen atoms to the total number of alkaline earth metal and Ce atoms is in the range of 0.1 to 0.5 inclusive.

6. The device according to claim 1, wherein said luminescent layer contains the first and second phosphors in a weight ratio of 85:15 to 20:80.

7. The device according to claim 1, wherein the difference between the emission peak wavelengths of said first and second phosphors is in the range of 20 to 70 nm.

8. The device according to claim 1, wherein said semi-conductor element emits light with a peak in the wavelength range of 440 to 460.

9. The device according to claim 1, which gives off light with a chromaticity coordinate in the range of (0.345±0.001, 0.352±0.001).

10. The device according to claim 1, wherein said first phosphor is produced by the steps of
mixing
a Sr material selected from the group consisting of nitride, oxide and hydroxide of Sr,
an Al material selected from the group consisting of nitride and oxide of Al,
a Si material selected from the group consisting of nitride, oxide and powdery simple substance of Si, and
a Ce material selected from the group consisting of oxide, nitride and halogenated compounds of Ce, to prepare a mixture; and then
firing the mixture.

11. The device according to claim 10, wherein said step of firing is carried out at a temperature in the range of 1500 to 2000° C. under 5 atm or more.

12. The device according to claim 10, wherein said step of firing is carried out in a nitrogen atmosphere.
